(19) United States
(12) Patent Application Publication
(10) Pub. No.: US 2020/0110240 A1
(43) Pub. Date: Apr. 9, 2020

(54) Lens Module

(71) Applicants: Sintai Optical (Shenzhen) Co., Ltd., ShenZhen City (CN); Asia Optical Co., Inc., Taichung (TW)

(72) Inventor: Po-Jen Wang, Taichung (TW)

(21) Appl. No.: 16/550,386

(22) Filed: Aug. 26, 2019

(30) Foreign Application Priority Data
Oct. 9, 2018 (CN) 201811172565.2

(51) Int. Cl. G02B 7/02

(52) U.S. Cl. CPC G02B 7/021

(57) ABSTRACT

A lens module includes a lens barrel, a first lens element, a first spacing ring and a second lens. The lens barrel has an opening and an inner circumferential surface, wherein an optical axis is defined by a center of the opening. The first lens element is disposed in the lens barrel and includes a lens body and a first bearing portion, wherein the first bearing portion is connected to the lens body. The second lens is disposed in the lens barrel. The lens body includes a first material, and the first bearing portion includes a second material. The first bearing portion is adjacent to the second lens and the first spacing ring in a first direction parallel to the optical axis and is adjacent to the lens body and the inner circumferential surface of the lens barrel in a second direction perpendicular to the optical axis.

### BACKGROUND OF THE INVENTION

### Field of the Invention

The invention relates to a lens module, and more particularly to a lens module having a lens barrel and a plurality of lenses fitted into the lens barrel in a single direction.

### Description of the Related Art

A prior lens module includes a lens barrel and a plurality of glass lenses. Due to limitations of the machining technology, the external form of each glass lens cannot be changed much. Generally, the shapes of the glass lenses are all different. An inner circumferential surface of the lens barrel is machined to have structure corresponding to the shapes of the glass lenses so that the glass lenses with different shapes can be fixed in the lens barrel. However, such structure requires the glass lenses to be separated into two groups and fitted into the lens barrel in two different directions, so that assembly of the lens module is time-consuming and costly.

In addition, machining errors generated during manufacture of the lens module may affect the coaxiality of the glass lenses fitted in the lens barrel, thereby decreasing the assembly quality of the lens module.

### BRIEF SUMMARY OF THE INVENTION

The invention provides a lens module, in which at least one lens has a plastic bearing portion (produced by injection molding) attached thereto, whereby all lenses can be sequentially fitted into a lens barrel of the lens module in single direction. Therefore, the assembly time can be decreased and the assembly quality can be also improved.

A lens module in accordance with an embodiment of the invention includes a lens barrel, a first lens element, a first spacing ring and a second lens. The lens barrel has an opening and an inner circumferential surface, wherein an optical axis is defined by a center of the opening. The first lens element is disposed in the lens barrel and includes a lens body and a first bearing portion, wherein the first bearing portion is connected to the lens body. The second lens is disposed in the lens barrel. The lens body includes a first material, and the first bearing portion includes a second material. The first bearing portion is adjacent to the second lens and the first spacing ring in a first direction parallel to the optical axis and is adjacent to the lens body and the inner circumferential surface of the lens barrel in a second direction perpendicular to the optical axis.

In another embodiment, the lens module further includes a second spacing ring disposed in the lens barrel, wherein the second spacing ring is disposed between the second lens and the first bearing portion in the first direction and is adjacent to the inner circumferential surface of the lens barrel in the second direction.

In yet another embodiment, the first bearing portion is placed against the lens body, the inner circumferential surface of the lens barrel and the first spacing ring and placed between the lens body and the inner circumferential surface of the lens barrel. The first bearing portion is placed against the second spacing ring or the second lens.

In another embodiment, the first material is glass, and the second material is plastic.

In yet another embodiment, the first bearing portion further includes a plurality of internal circumferential surfaces disposed with respect to each other and facing the optical axis, and a surface treatment is applied to the internal circumferential surfaces.

In another embodiment, the second lens includes a second bearing portion. The first lens further includes a light-shielding portion extending from the first bearing portion towards the optical axis in the second direction.

In yet another embodiment, the first lens element has a first diameter, the lens body has a second diameter, and the lens module satisfies: M/A>1.12, where M is the first diameter, and A is a second diameter.

In another embodiment, the first bearing portion has a length in the second direction, the first bearing portion further includes a ring-shaped surface facing the opening and having an area, the lens body has a second diameter, and the lens module satisfies: 0.1 mm²<(D×B)/A<4.5 mm², where D is the area of the ring-shaped surface, B is the length of the first bearing portion, and A is the second diameter.

In yet another embodiment, the first bearing portion has a width in the first direction, the lens body has a second diameter, and the lens module satisfies: 0.19≤E/A≤0.8, where E is the width of the first bearing portion, and A is the second diameter.

In another embodiment, the first bearing portion further has a thickness in the second direction, and the lens module further satisfies: 0.13 mm²≤F×E<2 mm², where E is the width of the first bearing portion, and F is the thickness of the first bearing portion.

In yet another embodiment, the first lens element has positive refractive power. The first bearing portion further has a length in the second direction, the first bearing portion further includes a ring-shaped surface facing the opening and having an area, and the lens module satisfies: 0.58 mm≤D/A≤4.5 mm and 0.09≤B/A≤0.5, where D is the area of the ring-shaped surface, B is the length of the first bearing portion, and A is the second diameter of the lens body.

In another embodiment, the first bearing portion further includes a ring-shaped surface and an inclined surface, the ring-shaped surface faces the opening and has an area, the inclined surface is sloped with respect to the inner circumferential surface and is placed at an angle with respect to the inner circumferential surface, and the lens module satisfies: 1.3 mm²<D/cos θ≤9 mm², where D is the area of the ring-shaped surface, and θ is the angle.

In yet another embodiment, the first lens element has a first diameter, the lens body has a second diameter, and lens module further satisfies: M/A>1.12, where M is the first diameter, and A is the second diameter.

In another embodiment, the first bearing portion has a length in the second direction, the lens body has a second diameter, and the lens module further satisfies: 0.1 mm²<(D×B)/A<4.5 mm², where D is the area of the ring-shaped surface, B is the length of the first bearing portion, and A is the second diameter.

In yet another embodiment, the first bearing portion has a width in the first direction and a thickness in the second direction, the lens body has a second diameter, and the lens module further satisfies: 0.19≤E/A≤0.8 and 0.13 mm²≤F×E<2 mm², where E is the width of the first bearing portion, A is the second diameter, and F is the thickness of the first bearing portion.

In another embodiment, the first lens element has positive refractive power. The first bearing portion is placed against the lens body, the inner circumferential surface of the lens barrel and the first spacing ring and placed between the lens body and the inner circumferential surface of the lens barrel. The first material is glass, and the second material is plastic.

In yet another embodiment, the first bearing portion further includes a plurality of internal circumferential surfaces disposed with respect to each other and facing the optical axis, and a surface treatment is applied to the internal circumferential surfaces. The second lens includes a second bearing portion. The first lens element further includes a light-shielding portion extending from the first bearing portion towards the optical axis in the second direction.

In another embodiment, the lens body has a second diameter, the first bearing portion has a length in the second direction, and the lens module further satisfies: 1.4 mm²<D/cos θ≤4 mm², 0.65 mm≤D/A≤1.8 mm, and 0.1≤B/A≤0.3, where D is the area of the ring-shaped surface, θ is the angle, A is the second diameter, and B is the length of the first bearing portion.

In yet another embodiment, the lens body has a second diameter, the first bearing portion has a width in the first direction, a thickness in the second direction and a length in the second direction, and the lens module further satisfies: 0.2 mm²<(D×B)/A<1.5 mm² and 0.75 mm²≤F×E<1.25 mm², where D is the area of the ring-shaped surface, A is the second diameter, B is the length of the first bearing portion, E is the width of the first bearing portion, and F is the thickness of the first bearing portion.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a sectional view of a lens module in accordance with a first embodiment of the invention;

FIG. 2A is a sectional view of the first lens element of FIG. 1;

FIG. 2B depicts a ring-shaped surface of a bearing portion of the first lens element of FIG. 2A;

FIG. 3 is a sectional view of a lens module in accordance with a second embodiment of the invention.

### DETAILED DESCRIPTION OF THE INVENTION

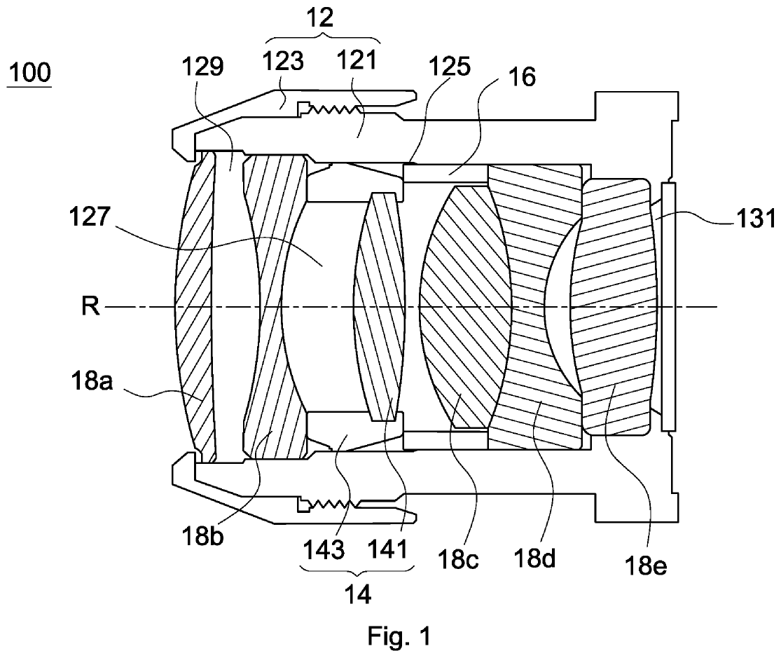

Referring to FIG. 1, a lens module 100 in accordance with a first embodiment of the invention includes a lens barrel 12, a first lens element 14, a spacing ring 16 and a second lens. It is worth noting that the second lens of the lens module 100 can be plural. In other words, the lens module 100 can include a plurality of second lenses 18a-18e, wherein the second lens 18a, the second lens 18b, the first lens element 14, the second lens 18c, the second lens 18d and the second lens 18e are sequentially fitted into the lens barrel 12 in a single direction.

The lens barrel 12 includes a first lens barrel portion 121 and a second lens barrel portion 123. The first lens barrel portion 121 has an inner circumferential surface 125, a lens room 127, a first opening 129 and a second opening 131, wherein a center of the first opening 129 and a center of the second opening 131 define a first axis R. The inner circumferential surface 125 is stepped and surrounds the first axis R for defining the lens room 127. An optical axis of the lens barrel 12 coincides with the first axis R, and therefore, the first axis R can be regarded as the optical axis of the lens barrel 12. It is worth noting that the lens room 127 has varying diameters diminished in a first direction (not shown) from the first opening 129 to the second opening 131, that is, the diameters of the lens room 127 are decreased from the first opening 129 to the second opening 131. In other words, a diameter of the first opening 129 is greater than a diameter of the second opening 131.

The first lens element 14 includes a lens body 141 and a bearing portion 143, and the bearing portion 143 surrounds and is fixed to the lens body 141. The lens body 141 includes a first material, and the bearing portion 143 includes a second material. In the first embodiment, the first material is glass, the second material is plastic, and the bearing portion 143 surrounds and is fixed to the lens body 141 by injection molding.

As shown in FIG. 1, during assembly, the second lens 18c, the second lens 18d and the second lens 18e are sequentially entered into the lens room 127 through the first opening 129 in the first direction. The second lens 18e is adjacent to the second opening 131 and is placed against the inner circumferential surface 125. The second lens 18d is placed against the second lens 18e and the inner circumferential surface 125. The second lens 18c is placed against the second lens 18d, and a ring-shaped space is formed between the second lens 18c and the inner circumferential surface 125. It is worth noting that the second lens 18c and the second lens 18d are fixed to each other by gluing before entered into the lens room 127. The spacing ring 16 is placed in the ring-shaped space and against the inner circumferential surface 125 and the second lens 18d. The first lens element 14 is entered into the lens room 127 through the first opening 129 in the first direction and has the bearing portion 143 propped against the inner circumferential surface 125 and the spacing ring 16. The second lens 18b and the second lens 18a are entered into the lens room 127 through the first opening 129 in the first direction, wherein the second lens 18b is placed against the inner circumferential surface 125 and the bearing portion 143 of the first lens element 14, and the second lens 18a is adjacent to the first opening 129 and is placed against the inner circumferential surface 125. Then, the second lens barrel portion 123 is disposed on an end of the first lens barrel portion 121 which is adjacent to the first opening 129 for preventing separation of the first lens element 14 and the second lenses 18a-18e from the lens room 127. As a result, the bearing portion 143 of the first lens element 14 is positioned between and contacts with (against) the lens body 141, the inner circumferential surface 125 of the first lens barrel portion 121, the spacing ring 16 and the second lens 18b, and no air space is formed at the contact therebetween. In this embodiment, the bearing portion 143 directly contacts the lens body 141, the inner circumferential surface 125, the spacing ring 16 and the second lens 18b. In another embodiment, the bearing portion 143, the lens body 141, the inner circumferential surface 125, the spacing ring 16 and the second lens 18b are fixed to each other by gluing. It is worth noting that the first lens element 14 and the second lenses 18a-18e cannot leave the lens room 127 through the second opening 131 since the diameter of the second opening 131 is smaller than each diameter of the first lens element 14 and the second lenses 18a-18e. It is also worth noting that the first axis R passes through centers of the first lens element 14 and the second lenses 18a-18e.

In the first embodiment, the bearing portion 143 is placed against the lens body 141, the spacing ring 16, the second lens 18b and the inner circumferential surface 125 of the first lens barrel portion 121. In such arrangement, the bearing portion 143 is constrained in four directions so that the reliability of the lens module 100 can be improved in the dropping test. Also, the bearing portion 143 can be less susceptible to variation of temperature.

It is worth noting that the first lens element 14 is provided with the bearing portion 143 to match the first lens barrel portion 121 which has varying inner diameters (diminished from the first opening 129 to the second opening 131), so that all lenses of the lens module 100 can be sequentially entered into the lens barrel 12 in a single direction. Therefore, the assembly of the lens module becomes simplified and the assembly time can be reduced. Furthermore, problem of the unqualified coaxiality of the lenses (caused by machining error) can be solved and the yield rate of the assembly of the lens module can be improved.

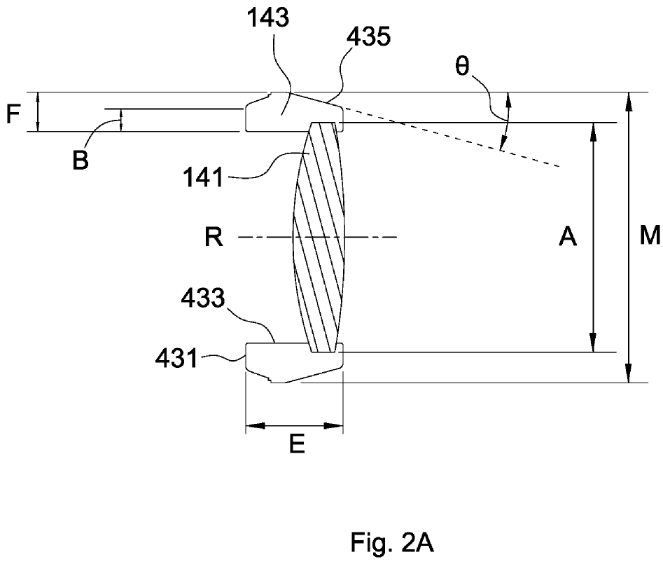

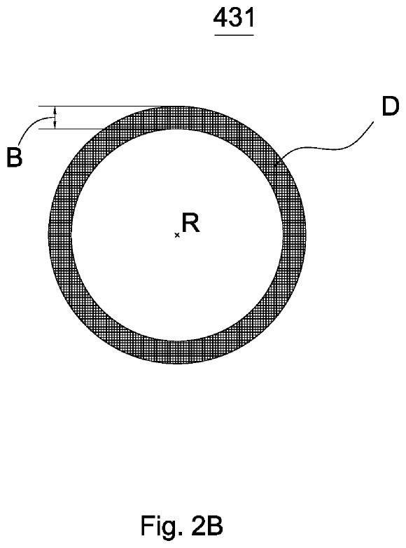

Referring to FIG. 2A, the first lens element 14 has a first diameter M in a second direction perpendicular to the first axis R, and the lens body 141 has a second diameter A in the second direction. When a ratio of the first diameter M to the second diameter A is greater than 1.12, the first lens element 14 has qualified coaxiality and bearing surface, so that the first lens element 14 is stably placed against the inner circumferential surface 125 of the first lens barrel portion 121. Therefore, if the lens module 100 satisfies a condition that the ratio of the first diameter M to the second diameter A is greater than 1.12, then the lens module 100 can be assembled by entering all lenses in a single direction. Compared to a lens module assembled by entering lenses in two opposite directions, the lens module 100 of the first embodiment has better coaxiality and the required assembly time can be decreased. In other words, the lens module 100 satisfies following condition (1):

M/A>1.12 (1),

wherein the second diameter ranges from 2 to 10 mm.

The bearing portion 143 has a ring-shaped surface 431, a plurality of internal circumferential surfaces 433 disposed with respect to each other and facing the first axis R, and an inclined surface 435. FIG. 2A depicts a section of the first lens element 14, wherein the ring-shaped surface 431 extends perpendicular to the first axis R and faces the first opening 129. The internal circumferential surfaces 433 extend parallel to the first axis R and are perpendicular to the ring-shaped surface 431. The inclined surface 435 extends in the first direction, is gradually close to the first axis R, and is sloped at an angle θ with respect to the inner circumferential surface 125 of the first lens barrel portion 121. By means of the arrangement of the inclined surface 435 and the angle θ, the first lens element 14 can be easily entered into the lens barrel 12 that is advantageous to the assembly of the lens module. In the first embodiment, the angle θ ranges from 0 to 30 degrees.

Referring to FIG. 2B, the ring-shaped surface 431 has an area D marked with grid lines and a length B measured in the second direction, wherein the area D is an area of the ring-shaped surface 431, and the length B is a vertical distance from a minimal circumference of the ring-shaped surface 431 to a maximal circumference of the ring-shaped surface 431. It is worth noting that the pressure from the second lens 18b is entirely applied to the bearing portion 143 when the lenses are entered into the lens barrel 12. Therefore, if the area D is too small or the length B is too short, the bearing portion 143 under the pressure from the second lens 18b is liable to deformation. In contrast, if the area D is too large or the length B is too long, then the bearing portion 143 is liable to have poor flatness that renders the second lens 18b placed against the bearing portion 143 inclined and the quality of the lens module poor. In other words, the area D or the length B has to be restricted to a predetermined range for avoiding the bearing portion 143 from the problems of deformation and poor flatness. In the first embodiment, the area D ranges from 1.16 to 9 mm², and the length B ranges from 0.18 to 1 mm. According to the ranges of the angle θ, the area D, the length B and the second diameter A described above, the lens module 100 is designed to further satisfy following conditions (2)-(5):

1.3 mm²<D/cos θ≤9 mm² (2)

0.58 mm≤D/A≤4.5 mm (3)

0.09≤B/A≤0.5 (4)

0.1 mm²<(D×B)/A<4.5 mm² (5)

Preferably, the lens module 100 is designed to further satisfy following conditions (6)-(9) which are amended from the conditions (2)-(5):

1.4 mm²<D/cos θ4 mm² (6)

0.65 mm≤D/A≤1.8 mm (7)

0.1≤B/A≤0.3 (8)

0.2 mm²<(D×B)/A<1.5 mm² (9).

In addition, the bearing portion 143 has a width E in the first direction parallel to the first axis R and a thickness F in the second direction perpendicular to the first axis R. The bearing portion 143 has another ring-shaped surface opposite to the ring-shaped surface 431, extending in the second direction and facing the second opening 131, and the width E is a vertical distance from the ring-shaped surface 431 facing the first opening 129 to the another ring-shaped surface facing the second opening 131. The thickness F is a vertical distance from a minimal circumference of the bearing portion 143 to a maximal circumference of the bearing portion 143. In the first embodiment, the width E ranges from 0.38 to 1.6 mm, and the thickness F ranges from 0.345 to 1.165 mm. It is worth noting that the first lens element and the adjacent lenses can be positively and accurately spaced and the number of the spacing ring can be decreased in the lens module 100, when the width E is within the described range (0.38 to 1.6 mm). Then, the assembly of the lens module 100 can be simplified, the assembly time and cost of the lens module 100 can be reduced, and the problem of tolerance arising from the spacing ring can be easily addressed. Further, when the thickness F is within the described range (0.345 to 1.165 mm), it is advantageous to injection molding for the bearing portion 143, the problems of poor assembly arising from deformation and poor flatness of the bearing portion 143 can be avoided, and the quality of the lens module can be controlled. According to the ranges of the width E, the thickness F and the second diameter A described above, the lens module 100 is designed to further satisfy following conditions (10)-(11):

0.19≤E/A≤0.8 (10)

0.13 mm²≤F×E<2 mm² (11).

Preferably, the lens module 100 is designed to further satisfy following condition (12) which is amended from the condition (11):

0.75 mm²≤F×E<1.25 mm² (12).

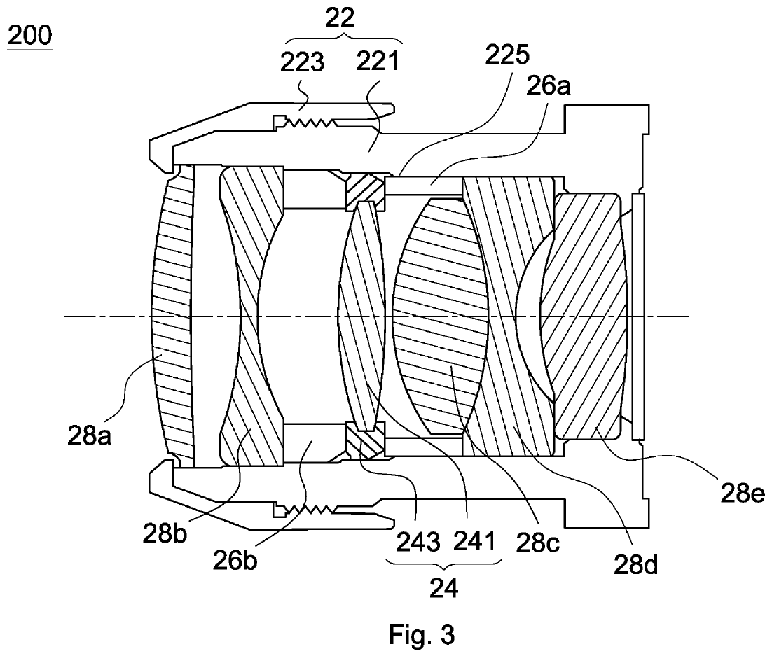

Referring to FIG. 3, a lens module 200 in accordance with a second embodiment of the invention includes a lens barrel 22, a first lens element 24, a first spacing ring 26a, a second spacing ring 26b and a plurality of second lenses 28a-28e. The difference between the first embodiment and the second embodiment is that the second spacing ring 26b is added between the second lens 28b and the first lens element 24. In other words, a bearing portion 243 of the first lens element 24 is placed between and against a lens body 241, an inner circumferential surface 225 of a first lens barrel portion 221, the first spacing ring 26a and the second spacing ring 26b. The arrangement of other elements and operation are similar to those of the first embodiment, and therefore the descriptions thereof are omitted.

In a third embodiment, a bearing portion (not shown) includes a plurality of internal circumferential surfaces disposed with respect to each other and facing a first axis. The internal circumferential surfaces of the bearing portion are processed by surface texture treatment or other surface treatment for reducing the ghost reflections in the lens module as well as achieving light extinction effects. For example, the surface treatment can be atomizing, blacking or printing. The arrangement of other elements and operation are similar to those of the first embodiment, and therefore the descriptions thereof are omitted.

In a fourth embodiment, a bearing portion (not shown) of a first lens element (not shown) includes a plurality of internal circumferential surfaces disposed with respect to each other and facing a first axis, and the first lens element further includes a light-shielding portion (not shown). The light-shielding portion extends from the internal circumferential surfaces of the bearing portion towards the first axis in a direction perpendicular to the first axis and is configured to control an optical effective diameter of the first lens element for controlling quantity of light entering the lens module so as to function as the known aperture or light-shielding ring. The arrangement of other elements and operation are similar to those of the first embodiment, and therefore the descriptions thereof are omitted.

As shown in FIG. 1, the bearing portion 143 is formed by extending from the lens body 141 towards the first opening 129 in the direction parallel to the first axis R. However, the invention is not limited thereto. The bearing portion 143 can be formed by extending towards both the first opening 129 and the second opening 131 as long as the width E is within the above range (0.38 to 1.6 mm).

In all the above embodiments, each of the second lenses can has a bearing portion attached thereto, similar to the first lens element. In other words, the lens module 100 includes at least one lens with a bearing portion attached thereto, and the bearing portion is not limited to be provided for the first lens.

What is claimed is:

1. A lens module, comprising:
a lens barrel having an opening and an inner circumferential surface, wherein an optical axis is defined by a center of the opening;
a first lens element disposed in the lens barrel and comprising a lens body and a first bearing portion, wherein the first bearing portion is connected to the lens body;
a first spacing ring; and
a second lens disposed in the lens barrel;
wherein the lens body comprises a first material, and the first bearing portion comprises a second material;
wherein the first bearing portion is adjacent to the second lens and the first spacing ring in a first direction parallel to the optical axis and is adjacent to the lens body and the inner circumferential surface of the lens barrel in a second direction perpendicular to the optical axis.

2. The lens module as claimed in claim 1, further comprising a second spacing ring disposed in the lens barrel, wherein the second spacing ring is disposed between the second lens and the first bearing portion in the first direction and is adjacent to the inner circumferential surface of the lens barrel in the second direction.

3. The lens module as claimed in claim 2, wherein the first bearing portion is placed against the lens body, the inner circumferential surface of the lens barrel and the first spacing ring and placed between the lens body and the inner circumferential surface of the lens barrel;
wherein the first bearing portion is placed against the second spacing ring or the second lens.

4. The lens module as claimed in claim 3, wherein the first material is glass, and the second material is plastic.

5. The lens module as claimed in claim 4, wherein the first bearing portion further comprises a plurality of internal circumferential surfaces disposed with respect to each other and facing the optical axis, and a surface treatment is applied to the internal circumferential surfaces.

6. The lens module as claimed in claim 4, wherein the second lens comprises a second bearing portion;
wherein the first lens element further comprises a light-shielding portion extending from the first bearing portion towards the optical axis in the second direction.

7. The lens module as claimed in claim 1, wherein the first lens element has a first diameter, the lens body has a second diameter, and the lens module satisfies: M/A>1.12, where M is the first diameter, and A is the second diameter.

8. The lens module as claimed in claim 1, wherein the first bearing portion has a length in the second direction, the first bearing portion further comprises a ring-shaped surface facing the opening and having an area, the lens body has a second diameter, and the lens module satisfies: 0.1 mm²<(D×B)/A<4.5 mm², where D is the area of the ring-shaped surface, B is the length of the first bearing portion, and A is the second diameter.

9. The lens module as claimed in claim 1, wherein the first bearing portion has a width in the first direction, the lens body has a second diameter, and the lens module satisfies: 0.19≤E/A≤0.8, where E is the width of the first bearing portion, and A is the second diameter.

10. The lens module as claimed in claim 9, wherein the first bearing portion further has a thickness in the second direction, and the lens module further satisfies: 0.13 mm²≤F×E<2 mm², where E is the width of the first bearing portion, and F is the thickness of the first bearing portion.

11. The lens module as claimed in claim 10, wherein the first lens element has positive refractive power;
wherein the first bearing portion further has a length in the second direction, the first bearing portion further comprises a ring-shaped surface facing the opening and having an area, and the lens module satisfies:
0.58 mm≤D/A≤4.5 mm; and
0.09≤B/A≤0.5;
where D is the area of the ring-shaped surface, B is the length of the first bearing portion, and A is the second diameter of the lens body.

12. The lens module as claimed in claim 1, wherein the first bearing portion further comprises a ring-shaped surface and an inclined surface, the ring-shaped surface faces the opening and has an area, the inclined surface is sloped with respect to the inner circumferential surface and is placed at an angle with respect to the inner circumferential surface, and the lens module satisfies: 1.3 mm²<D/cos θ≤9 mm², where D is the area of the ring-shaped surface, and θ is the angle.

13. The lens module as claimed in claim 12, wherein the first lens element has a first diameter, the lens body has a second diameter, and lens module further satisfies: M/A>1.12, where M is the first diameter, and A is the second diameter.

14. The lens module as claimed in claim 12, wherein the first bearing portion has a length in the second direction, the lens body has a second diameter, and the lens module further satisfies: 0.1 mm²<(D×B)/A<4.5 mm², where D is the area of the ring-shaped surface, B is the length of the first bearing portion, and A is the second diameter.

15. The lens module as claimed in claim 12, wherein the first bearing portion has a width in the first direction and a thickness in the second direction, the lens body has a second diameter, and the lens module further satisfies:
0.19≤E/A≤0.8; and
0.13 mm²≤F×E<2 mm²;
where E is the width of the first bearing portion, A is the second diameter, and F is the thickness of the first bearing portion.

16. The lens module as claimed in claim 12, wherein the first lens element has positive refractive power;
wherein the first bearing portion is placed against the lens body, the inner circumferential surface of the lens barrel and the first spacing ring and placed between the lens body and the inner circumferential surface of the lens barrel;
wherein the first material is glass, and the second material is plastic.

17. The lens module as claimed in claim 16, wherein the first bearing portion further comprises a plurality of internal circumferential surfaces disposed with respect to each other and facing the optical axis, and a surface treatment is applied to the internal circumferential surfaces;
wherein the second lens comprises a second bearing portion;
wherein the first lens element further comprises a light-shielding portion extending from the first bearing portion towards the optical axis in the second direction.

18. The lens module as claimed in claim 12, wherein the lens body has a second diameter, the first bearing portion has a length in the second direction, and the lens module further satisfies:
1.4 mm²<D/cos θ≤4 mm²;
0.65 mm≤D/A≤1.8 mm; and
0.1≤B/A≤0.3;
where D is the area of the ring-shaped surface, θ is the angle, A is the second diameter, and B is the length of the first bearing portion.

19. The lens module as claimed in claim 12, wherein the lens body has a second diameter, the first bearing portion has a width in the first direction, a thickness in the second direction and a length in the second direction, and the lens module further satisfies:
0.2 mm²<(D×B)/A<1.5 mm²; and
0.75 mm²≤F×E<1.25 mm²;
where D is the area of the ring-shaped surface, A is the second diameter, B is the length of the first bearing portion, E is the width of the first bearing portion, and F is the thickness of the first bearing portion.
